(19) United States
(12) Patent Application Publication
(10) Pub. No.: US 2006/0008260 A1
(43) Pub. Date: Jan. 12, 2006

(54) Disk player, display control method thereof, data analyzing method thereof

(76) Inventors: Yu-Chi Chen, Hsinchu City (TW); Wen-Kuan Chen, Jhudong Township (TW); Chien-Min Chen, Hsinchu City (TW)

Correspondence Address: J C PATENTS, INC., 4 VENTURE, SUITE 250, IRVINE, CA, 92618, US

(21) Appl. No.: 11/227,730

(22) Filed: Sep. 14, 2005

(30) Foreign Application Priority Data
May 19, 2005 (TW) 94116258
Jan. 12, 2004 (TW) 093100708

(51) Int. Cl. H04N 5/781

(52) U.S. Cl. 386/125; 386/126

(57) ABSTRACT

A disk player including a control module, a navigator, a de-multiplexer, a decoder, a text recognition module and a data comparing module is provided. The navigator reads an audio and video (AV) data according to a display control signal outputted by the control module. An audio decoding signal, a video decoding signal, a caption image and a display time information corresponding to the caption image are decoded by the decoder according to an audio data, a video data, and a sub-picture unit (SPU), respectively, divided from the AV data by the de-multiplexer. The text recognition module recognizes the caption image as a first text data. The data comparing module receives a second text data provided by a user or from a database and compares the first text data with the second text data to export an analysis result or another display time information corresponding to the second text data.

### CROSS-REFERENCE TO RELATED APPLICATION

This application claims the priority benefit of Taiwan application serial no. 94116258, filed on May 19, 2005. All disclosure of the Taiwan application is incorporated herein by reference.

### BACKGROUND OF THE INVENTION

1. Field of the Invention

The present invention relates to a disk player, and more particularly, to a DVD disk player, a method for controlling the DVD display, and a data analyzing method thereof.

2. Description of the Related Art

An optical disk has some advantages, for example, high storage capacity, easy storage, long time preservation, low cost and data durability, it has become one of the indispensable optical storage mediums in our daily life and gradually replaced the conventional magnetic storage medium. For example, a digital versatile disk (DVD) includes audio and video (AV) display data such as video, audio and captions, and display control information.

FIG. 1 schematically shows a block diagram of a conventional DVD player. Referring to FIG. 1, the conventional DVD player 200 comprises a navigator 210, a de-multiplexer 220, a decoder 230, an audio post process unit 240, an audio output unit 250, a video post process unit 260, a video output unit 270, a user interface 280 and a control module 290. Wherein, the control module 290 provides a display control signal to the navigator 210 according to a signal input by the user, and the navigator 210 reads an AV data from an optical disk 100 based on the display control signal.

The decoder 220 divides the AV data into an audio data, a video data and a sub-picture unit (SPU) that are then respectively provided to an audio decoder 232, a video decoder 234 and a sub-picture decoder 236 of the decoder 230. To be more specifically, a display information (including time, position, color contrast, etc.) is decoded by the sub-picture decoder 236 based on the sub-picture unit, and a corresponding caption image is output by the sub-picture decoder 236 according to the display time corresponded to the caption image. In addition, the caption image is usually with a bitmap format.

Then, the video post process unit 260 receives the caption image from the sub-picture decoder 236, and merges the caption image with an image output from the video decoder 234. Moreover, the display time is determined by the audio decoder 232, the video decoder 234, and the sub-picture decoder 236 according to the system timing. A general DVD player usually uses a display time of video data or audio data as its base reference of display. It is to be noted that the navigator 210 may further receive a plug-in caption data for display captions of different languages on the screen. In addition, the AV data in the optical disk 100 further contains a Line-21 information for providing the caption information, wherein the so-called “Line-21 information” is the information hidden in the 21^{th} scanning line.

As mentioned above, the user control signals received by the conventional DVD player 200 comprise various functions, for example, fast play, slow play, reverse fast play, reverse slow play, and fixed pattern play (including A-to-B replay). However, such AV display control uses the navigator display information, the video display time, or the audio output time as its base reference for controlling the display time. A user is not able to use the caption image as its base reference for controlling the display time. In addition, such conventional DVD player 200 cannot not analyze the digital AV content or provide the database corresponding to the digital content.

### SUMMARY OF THE INVENTION

Therefore, it is an object of the present invention to provide a disk player that recognizes the caption image as a text data in order to control the AV data display.

It is another object of the present invention to provide a disk player that provides the functions such as word search and AV data classification.

It is yet another object of the present invention to provide a display control method for recognizing the caption image as a text data in order to control the AV data display.

It is still yet another object of the present invention to provide a data analyzing method for recognizing the caption image as a text data in order to classify the AV data.

In order to achieve the objects mentioned above and others, the present invention provides a disk player. The disk player includes a control module, a navigator, a de-multiplexer, a decoder, a text recognition module and a data comparing module. Wherein, the control module outputs a display control signal according to an operation command. The navigator reads an audio and video (AV) data according to the display control signal. The de-multiplexer divides the AV data into an audio data, a video data and a sub-picture unit. An audio decoding signal, a video decoding signal, a caption image and a display time information corresponding to the caption image are decoded by the decoder according to the audio data, the video data and the sub-picture unit, respectively. The text recognition module recognizes the caption image as a first text data. The data comparing module receives a second text data and compares the first and the second text data to export an analysis result or a display time information corresponding to the second text data.

In accordance with a preferred embodiment of the present invention, the text recognition module mentioned above is an optical character recognition (OCR) module.

In accordance with the preferred embodiment of the present invention, the second text data mentioned above is input by the user for displaying the AV data corresponded to the second text data.

In accordance with the preferred embodiment of the present invention, the disk player mentioned above further comprises a database. The second text data is from the database, and an analysis result is output by the data comparing module. The database at least comprises either a build-in database or a user-defined database. In addition, the disc player mentioned above further comprises a word selection module, and the user uses the word selection module to select the first text data as the input of the data comparing module.

In accordance with the preferred embodiment of the present invention, the disk player mentioned above further comprises a user interface. The user interface is electrically coupled to the control module, and an operation command is provided to the control module through the user interface by the user.

In accordance with the preferred embodiment of the present invention, the decoder mentioned above is for example an audio decoder, a video decoder or a sub-picture decoder. Wherein, the audio decoder receives and decodes an audio data from the de-multiplexer to generate an audio decoding signal. The video decoder receives and decodes a video data from the de-multiplexer to generate a video decoding signal. The sub-picture decoder receives and decodes a sub-picture unit from the de-multiplexer to generate a caption image and a display time information corresponding to the caption image.

The disk player mentioned above further comprises a video post process unit and a video output unit. Wherein, the video post process unit receives the video decoding signal, the caption image, and the display time information corresponding to the caption image for generating a video signal. The video output unit receives the video signal and generates a video output signal.

The disk player mentioned above further comprises an audio post process unit and an audio output unit. Wherein, the audio post process unit receives the audio decoding signal and generates an audio signal. The audio output unit receives the audio signal and generates an audio output signal.

In accordance with the preferred embodiment of the present invention, the navigator provides a setup signal to the text recognition module in order to control the types of text to be recognized by the text recognition module.

In order to achieve the objects mentioned above and others, the present invention provides a disk player. The disk player comprises a control module, an AV display unit, a text recognition module and a data comparing module. Wherein, the control module outputs a display control signal according to an operation command. The AV display unit reads an AV data and outputs an audio output signal, a video output signal, a caption image, and a display time information corresponding to the caption image according to the display control signal. The text recognition module recognizes the caption image as a first text data. The data comparing module receives a second text data, compares the first text data with the second text data, and exports an analysis result or a display time information corresponding to the second text data.

In accordance with the preferred embodiment of the present invention, the text recognition module mentioned above is for example an OCR module.

In accordance with the preferred embodiment of the present invention, the disk player mentioned above further comprises a user interface, electrically coupled to the control module. The operation command is input to the control module through the user interface by the user.

In accordance with the preferred embodiment of the present invention, the second text data mentioned above is input by the user for displaying the AV data corresponded to the second text data.

In accordance with the preferred embodiment of the present invention, the disk player mentioned above further comprises a database. The second text data is from the database, and an analysis result is output by the data comparing module. The database at least comprises either a build-in database or a user-defined database. In addition, the disc player mentioned above further comprises a word selection module, and the user uses the word selection module to select the first text data as the input of the data comparing module.

In accordance with the preferred embodiment of the present invention, the data comparing module mentioned above further receives a Line-21 information or a plug-in caption information. The data comparing module compares the second text data with the corresponding Line-21 information or the plug-in caption information to export the analysis result or the display time information corresponding to the second text data.

In accordance with the preferred embodiment of the present invention, the AV display unit mentioned above comprises a navigator, a de-multiplexer, and a decoder. Wherein, the navigator electrically coupled to the control module reads the AV data according to the display control signal. The de-multiplexer divides the AV data into an audio data, a video data, and a sub-picture unit. The decoder decodes the audio data, the video data, and the sub-picture unit into an audio decoding signal, a video decoding signal, a caption image and a display time information corresponding to the caption image.

The decoder mentioned above is for example an audio decoder, a video decoder and a sub-picture decoder. Wherein, the audio decoder receives and decodes an audio data from the de-multiplexer to generate an audio decoding signal. The video decoder receives and decodes a video data from the de-multiplexer to generate a video decoding signal. The sub-picture decoder receives and decodes a sub-picture unit from the de-multiplexer to generate a caption image and a display time information corresponding to the caption image.

The disk player mentioned above further comprises a video post process unit and a video output unit. Wherein, the video post process unit receives the video decoding signal, the caption image, and the display time information corresponding to the caption image to generate a video signal. The video output unit receives the video signal and generates a video output signal.

The disk player mentioned above further comprises an audio post process unit and an audio output unit. Wherein, the audio post process unit receives the audio decoding signal and generates an audio signal. The audio output unit receives the audio signal and generates an audio output signal.

In accordance with the preferred embodiment of the present invention, the navigator provides a setup signal to the text recognition module in order to control the types of text to be recognized by the text recognition module.

In order to achieve the objects mentioned above and others, the present invention provides a display control method for controlling an AV data display. The display control method comprises the following steps. First, a caption image and a display time information corresponding to the caption image are decoded from the AV data, and the caption image is converted into a first text data. Then, the first text data is compared with a second text data input by the user. Finally, the display time information corresponding to the second text data is output in order to display the AV data corresponding to the display time information.

In accordance with the preferred embodiment of the present invention, the method of converting the caption image into the first text data mentioned above is for example an OCR technique.

In accordance with the preferred embodiment of the present invention, the method of decoding the AV data may be an asynchronous output.

In order to achieve the objects mentioned above and others, the present invention provides a data analyzing method for analyzing an AV data. Wherein, the display control method comprises the following steps. First, a caption image is decoded from the AV data, and the caption image is converted into a first text data. Then, the first text data is compared with a second text data input by the user or from a database. Finally, an analysis result is output.

In accordance with the preferred embodiment of the present invention, the method of converting the caption image into the first text data mentioned above is for example an OCR technique.

In accordance with the preferred embodiment of the present invention, the method of comparing the first text data with the second text data from the database is for example a database search technique.

In accordance with the preferred embodiment of the present invention, after the step of converting the caption image into the first text data, the method further comprises selecting a part from the first text data for comparison.

In accordance with the preferred embodiment of the present invention, the method for decoding the caption image may be an asynchronous output.

In summary, the caption image is converted into a text data in the present invention, thus the text data can be used by the user to control the display. In addition, the AV data is classified by the user based on the text data converted from the caption image. Moreover, the text data converted from the caption image can also be used by the user to do word searching.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a block diagram of a conventional DVD player.

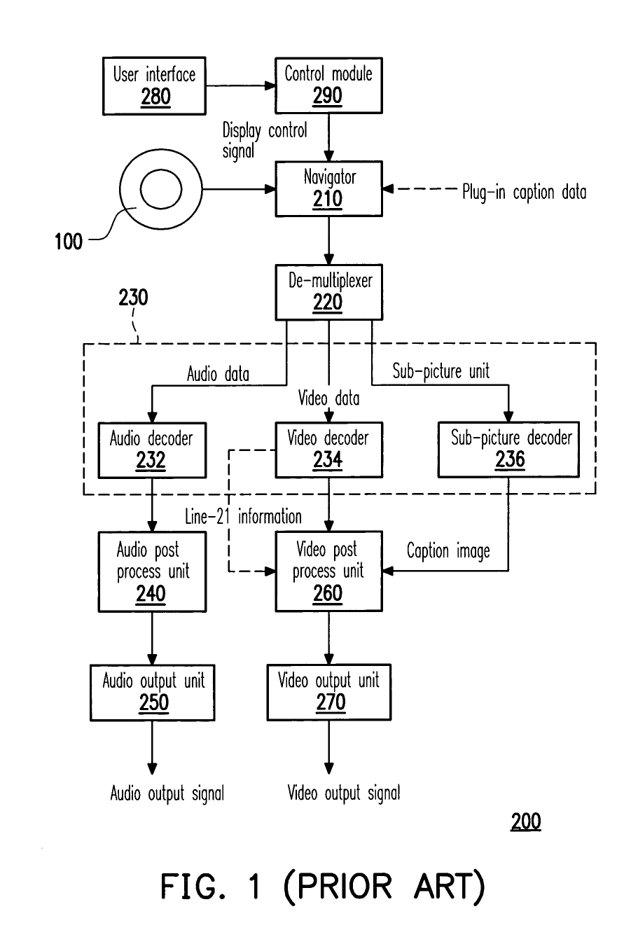

FIG. 2 schematically shows a block diagram of a DVD player according to a first preferred embodiment of the present invention.

FIG. 3 schematically shows a flow chart illustrating a word monitoring function of the DVD player according to the first preferred embodiment of the present invention.

FIG. 4 schematically shows a flow chart illustrating an AV display control function of the DVD player according to the first preferred embodiment of the present invention.

FIG. 5 schematically shows a block diagram of a DVD player according to a second preferred embodiment of the present invention.

FIG. 6 schematically shows a flow chart illustrating a data analyzing function of the DVD player according to the second preferred embodiment of the present invention.

FIG. 7 schematically shows a block diagram of a DVD player according to a third preferred embodiment of the present invention.

FIG. 8 schematically shows a flow chart illustrating a word query function of the DVD player according to the third preferred embodiment of the present invention.

### DESCRIPTION OF PREFERRED EMBODIMENTS

### First Embodiment

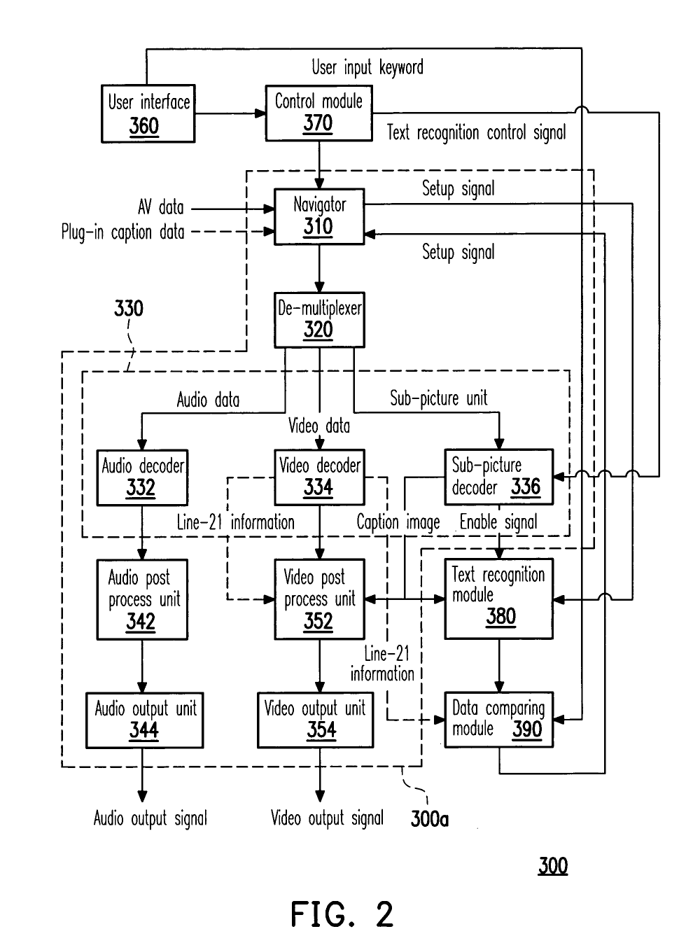

FIG. 2 schematically shows a block diagram of a DVD player according to a first preferred embodiment of the present invention. Referring to FIG. 2, the disk player 300 comprises a control module 370, a navigator 310, a de-multiplexer 320, a decoder 330, a text recognition module 380, and a data comparing module 390. Wherein, the user inputs an operation command to the control module 370 through a user interface 360; and the operation command is for example the command of various functions such as fast play, slow play, reverse fast play, reverse slow play, and fixed pattern play (including A-to-B replay). It is to be noted that the operation command of the present embodiment further comprises word monitoring, display control, data analysis or word search, etc. The details are described hereinafter.

The control module 370 outputs a display control signal according to the operation command; and the navigator 310 reads an AV data based on the display control signal. In addition, the AV data can be read from hard drive, optical disk, Internet, or other types of data storage media. The de-multiplexer 320 divides the AV data into an audio data, a video data and a sub-picture unit. Moreover, the decoder 330 decodes the audio data, video data, and sub-picture unit into an audio decoding signal, a video decoding signal, a caption image and a display time information corresponding to a caption image, respectively.

To be more specifically, the decoder 330 comprises an audio decoder 332, a video decoder 334 and a sub-picture decoder 336. Wherein, the audio decoder 332 receives and decodes an audio data from the de-multiplexer 320 to generate an audio decoding signal. In addition, the audio post process unit 342 receives the audio decoding signal and generates an audio signal. The audio output unit 344 receives the audio signal and generates an audio output signal. Moreover, the audio output signal can be transmitted to a speaker (not shown).

The video decoder 334 receives and decodes a video data from the de-multiplexer 320 and generates a video decoding signal. In addition, the sub-picture decoder 336 receives and decodes a sub-picture unit from the de-multiplexer 320 and generates a caption image and a display time information corresponding to the caption image. Moreover, the video post process unit 352 receives the video decoding signal, the caption image, and the display time information corresponding to the caption image to generate a video signal. The video output unit 354 receives the video signal and generates a video output signal. Furthermore, the video output signal can be transmitted to a screen.

It is to be noted that the text recognition module 380 recognizes the caption image as a first text data, and the text recognition module 380 can be an OCR module or other text recognition module. In addition, the text recognition module 380 receives a setup signal from the control module 370 for determining the type of text to be recognized. In order to store the recognized first text data, the text recognition module 380 may further comprise a memory unit (not shown). Moreover, the data comparing module 390 receives a second text data and compares the first text data with the second text data so as to export an analysis result or a display time information corresponding to the second text data. Furthermore, all of the navigator 310, the de-multiplexer 320, the decoder 330, the audio post process unit 342, the audio output unit 344, the video post process unit 352 and the video output unit 354 mentioned above may be cooperated and referred to as an AV display unit 300a. By the way, the text recognition module 380 and the data comparing module 390 may be added into the AV display unit 300a with a plug-in method in order to provide additional functions. The operation flow of the disk player 300 is described in greater detail hereinafter.

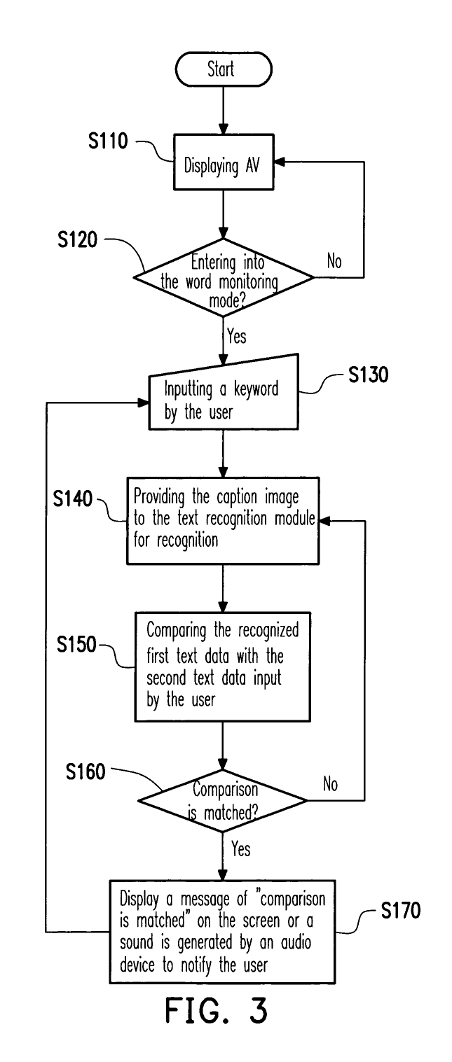

FIG. 3 schematically shows a flow chart illustrating a word monitoring function of the DVD player according to the first preferred embodiment of the present invention. Referring to FIG. 2 and FIG. 3, the word monitoring function comprises the following steps. First, the AV is displayed in step S110. Then, after an operation command (word monitoring) is input by the user through the user interface 360, it is determined whether to enter into the word monitoring mode in step S120.

Then, in step S130, the user inputs a keyword through the user interface 360, and the keyword is input to the data comparing module 390. In addition, the user may also control the navigator 310 through the user interface 360 and the control module 370 to output a setup signal to the text recognition module 380, such that the type of text to be recognized by the text recognition module 380 is set. Afterwards, the sub-picture decoder 336 decodes the caption image of the AV data and the display time information corresponding to the caption image. In addition, the sub-picture decoder 336 receives a text recognition control signal from the control module 370 and inputs an enable signal to the text recognition module 380 based on the text recognition control signal so as to activate the text recognition module 380. Then, in step S140, the caption image is provided to the text recognition module 380 to recognize the first text data. Wherein, the method of converting the caption image into the first text data can be an OCR technique.

Then, in step S150, the recognized first text data is compared with the second text data input by the user. In step S160, it is determined whether the comparison is matched or not. If it is not matched, steps S140, S150, and S160 are repeated until all of the caption images in the AV data are recognized. Otherwise, if the comparison is matched, step S170 is performed, where a message of “comparison is matched” is displayed on the screen or a voice is generated by the audio device to notify the user.

In summary, in the present embodiment, the caption image in the AV data is converted into text data with the OCR technique, thus the text data can be used by the user. For example, it is possible to search whether a specific keyword is existed in the AV data or not as shown in FIG. 3. However, since each caption image has individual corresponding display time information, it is possible for the user to determine the start point and the end point of the AV data display by inputting the keyword, and its detail is described in greater detail hereinafter.

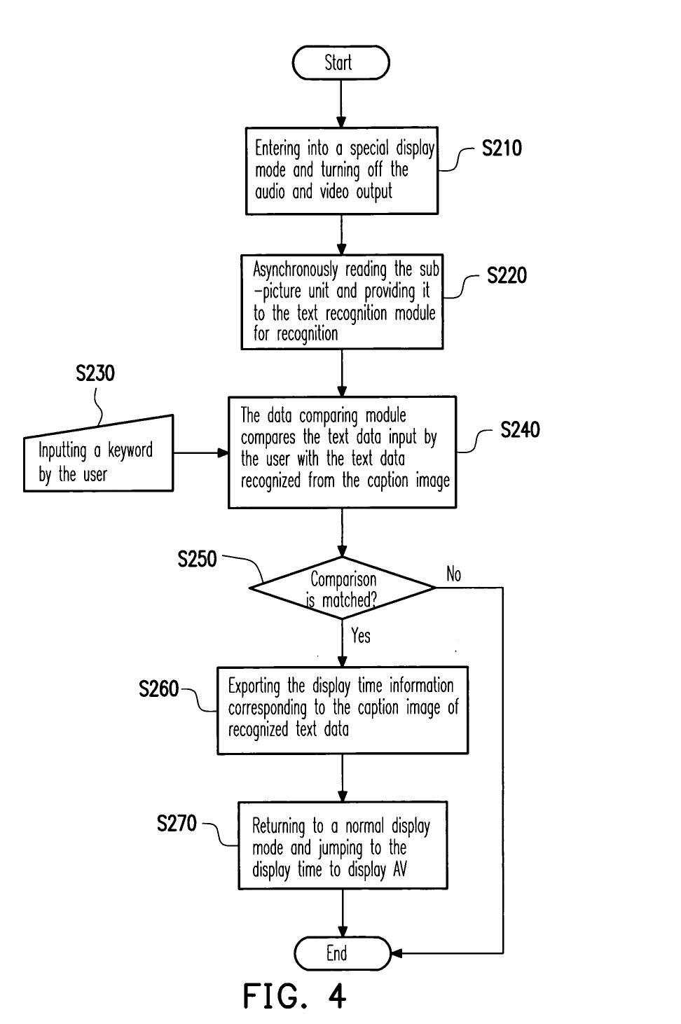

FIG. 4 schematically shows a flow chart illustrating an AV display control function of the DVD player according to the first preferred embodiment of the present invention. Referring to FIG. 2 and FIG. 4, the AV display control function comprises the following steps. First in step S210, after an operation command is input by the user via the user interface 360, the system enters into a special display mode and the output of the audio and video is turned off. Meanwhile, the user controls the navigator 310 through the user interface 360 and the control module 370 to output a setup signal to the text recognition module 380, such that the type of text to be recognized by the text recognition module 380 can be configured. Then, in step S220, the sub-picture unit is asynchronously exported and provided to the text recognition module 380 for recognition. Here, the so-called “asynchronously exporting the sub-picture unit” means to input the sub-picture unit to the text recognition module 380 without considering the display time, such that the speed of exporting the sub-picture unit can be improved.

Then, in step S230, a keyword is input to the data comparing module 390. It is to be noted that step S230 and step S220 may be performed in an arbitrary order. In step S240, the data comparing module compares the text input by the user with the text data recognized from the caption image. In step S250, if the comparison is not matched, the AV display control function is terminated. If the comparison is matched, the display time information corresponding to the caption image of the recognized text data is exported in step S260. Then, in step S270, the operation mode is back to the normal display mode, and AV is displayed starting from a time point indicated by the display time information provided in step S260.

To be more specifically, the data comparing module 390 provides the display time information corresponding to the caption image of the recognized text data to the navigator 310; and the navigator 310 reads the AV data to be displayed according to the display time information. In other words, it is possible for the user to control the AV data display by inputting a keyword. Furthermore, if the navigator 310 reads the AV data with the Line-21 information or the plug-in caption information, the data can be directly compared without using the text recognition module 380.

### Second Embodiment

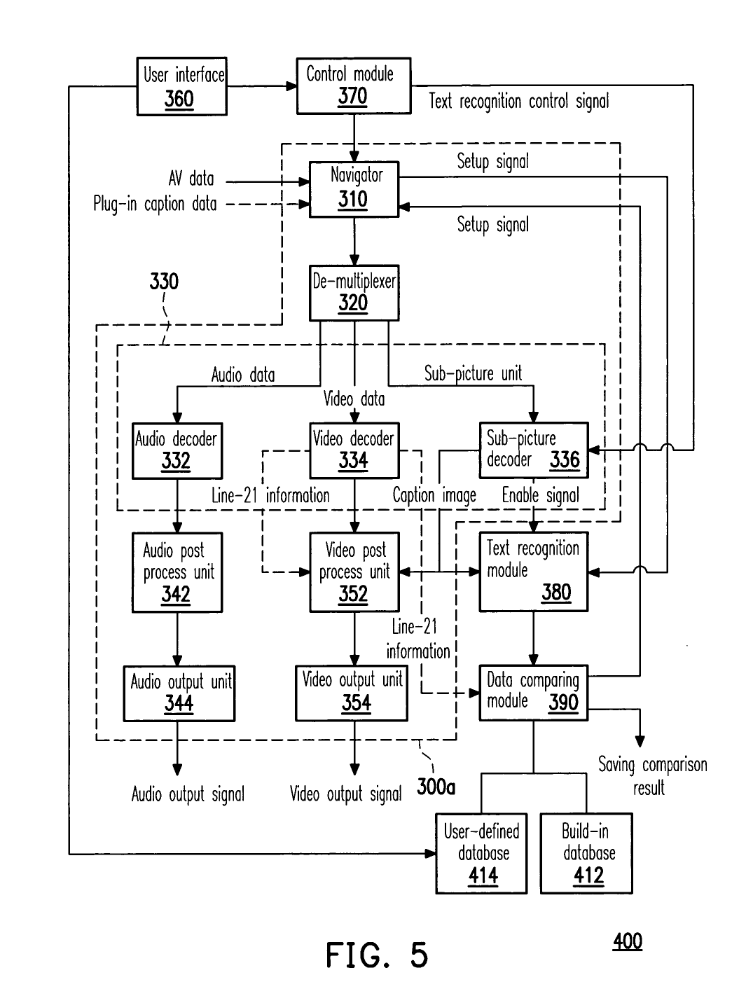

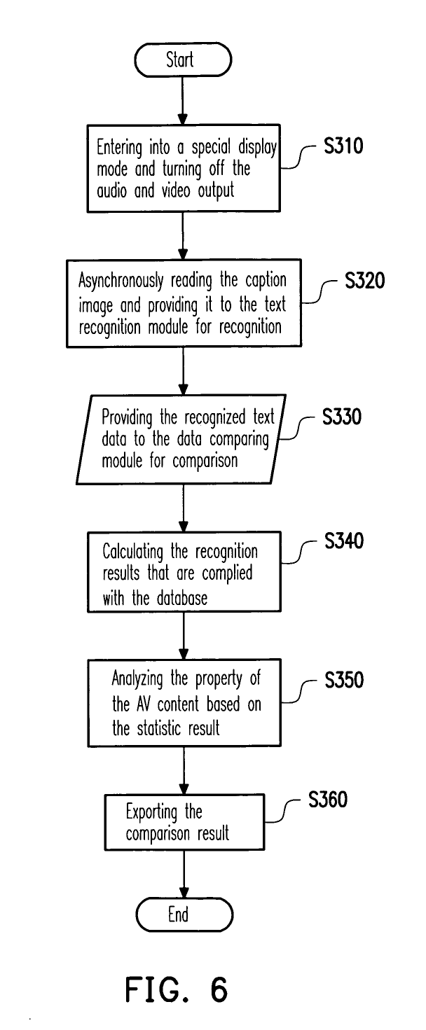

FIG. 5 schematically shows a block diagram of a DVD player according to a second preferred embodiment of the present invention, and FIG. 6 schematically shows a flow chart illustrating a data analyzing function of the DVD player according to the second preferred embodiment of the present invention. Referring to FIG. 5, the second embodiment is similar to the first embodiment except that the disk player 400 further comprises a build-in database 412. For example, the build-in database 412 is an English-Chinese dictionary, a TOEFL dictionary or a dirty word book. In other words, the text data recognized from the caption image may be compared with the build-in database 412, such that the content of the AV data can be classified. In addition, the data source of the data comparing module 390 may be a user-defined database, wherein the words additionally input by the user become a part of the user-defined database. It is to be noted that both the build-in database 412 and the user-defined database 414 can be stored in either an external storage media or a build-in storage media.

Referring to FIG. 5 and FIG. 6, the data analyzing function comprises the following steps. First in step S310, after an operation command is input by the user via the user interface 360, the system enters into a special display mode and the output of the audio and video is turned off. Meanwhile, the user controls the navigator 310 through the user interface 360 and the control module 370 to provide a setup signal to the text recognition module 380, such that the type of text to be recognized by the text recognition module 380 can be configured. Then, in step S320, the caption image is asynchronously read and output to the text recognition module 380 for recognition. In step S330, the recognized text data is output to the data comparing module 390 for comparison. The method for comparing the recognized text data with the build-in database 412 or the user-defined database 414 is for example a database search technique.

Then, in step S340, the recognition results complying with the database are calculated. Then, the property of the AV data content is analyzed based on the statistic result in step S350. Finally, in step S360, a comparison result is exported. It is to be noted that the comparison result may be exported to the screen or stored in the memory unit. In addition, the comparison result for example includes whether the difficult level of the analyzed AV data is corresponded to the TOEFL exam, or whether the analyzed AV data is suitable for the underage to watch. Furthermore, if the navigator 310 reads the AV data with the Line-21 information or the plug-in caption information, the data can be directly compared without using the text recognition module 380.

### Third Embodiment

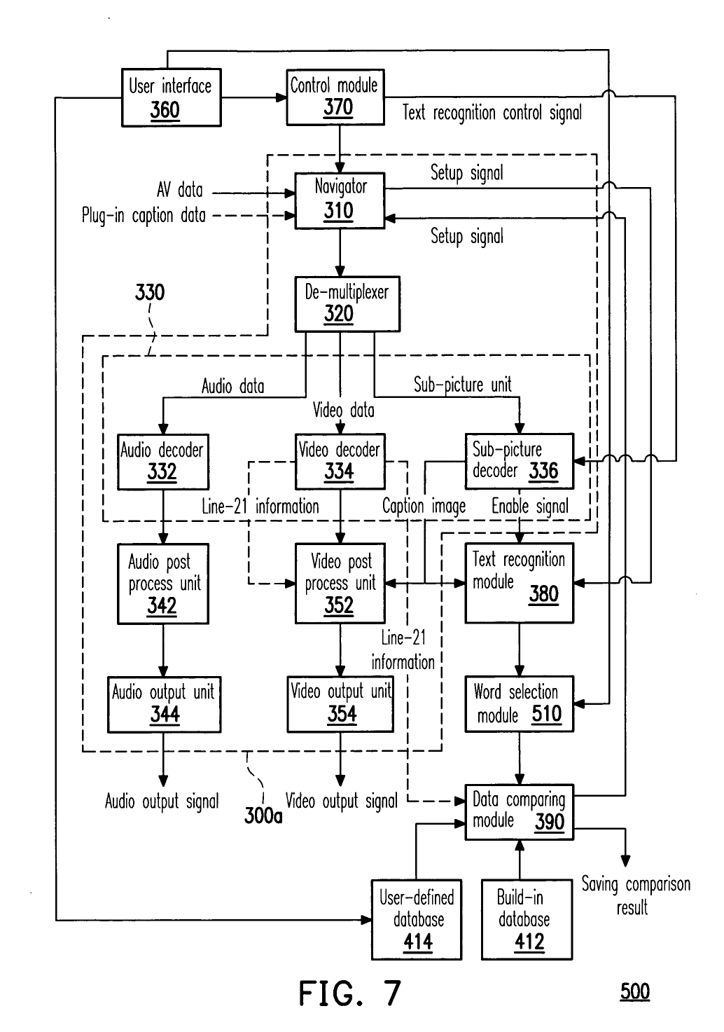

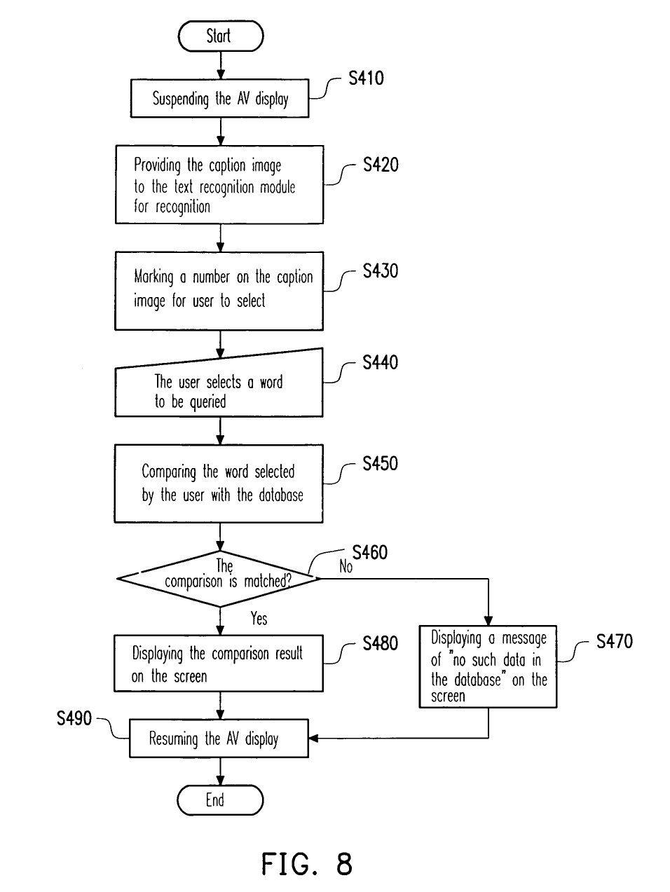

FIG. 7 schematically shows a block diagram of a DVD player according to a third preferred embodiment of the present invention, and FIG. 8 schematically shows a flow chart illustrating a word query function of the DVD player according to the third preferred embodiment of the present invention. Referring to FIG. 7, the third embodiment is similar to the second embodiment except that the disk player 500 further comprises a word selection module 510; and the user can select the text data to be queried through the word selection module 510.

Referring to FIG. 7 and FIG. 8, the data analyzing function comprises the following steps. First in step S410, an operation command is input by the user via the user interface 360 to suspend the AV display. Meanwhile, the user controls the navigator 310 through the user interface 360 and the control module 370 to output a setup signal to the text recognition module 380, such that the type of text to be recognized by the text recognition module 380 can be configured. Then, in step S420, the caption image decoded by the sub-picture decoder 336 is input to the text recognition module 380 for recognition. Then, in step S430, a number is marked on the caption image for user to select.

Then, the user selects the text to be queried through the user interface 360 in step S440. In step S450, the text selected by the user is provided to the data comparing module 390 and compared with a database. For example, the database may be a build-in database 412 or a user-defined database 414. In addition, the build-in database 412 or the user-defined database 414 is for example an English-Chinese dictionary, an English-to-English dictionary or a Chinese-to-English dictionary.

Then, in step S460, it is determined whether the comparison is matched. If the comparison is not matched, steps S470 and S490 are sequentially performed. In step S470, a message of “no such data in the database” is displayed on the screen, and in step S490, the AV data display is resumed. If the comparison is matched, steps S480 and S490 are sequentially performed. In step S480, a comparison result is displayed on the screen. In other words, the user is able to use the word query function to display the representation of the queried word while watching the AV information. Furthermore, if the navigator 310 reads the AV data with the Line-21 information or the plug-in caption information, the data can be directly compared without using the text recognition module 380.

In summary, the disk player and the methods for display control and data analysis provided by the present invention at least have the following advantages:

1. Compared to the conventional technique, with the disk player provided by the present invention, the user can use the caption image to control the AV display.

2. Since the caption image of the AV data can be recognized as text data, the AV data can be classified by the user based on the text data.

3. Since the caption image of the AV data can be recognized as text data, when the AV data is displayed, the user can query the representation of word meanings shown on the screen.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A disk player, comprising:
a control module for providing a display control signal based on an operation command;
a navigator for reading an AV data based on the display control signal;
a de-multiplexer for dividing the AV data into an audio data, a video data, and a sub-picture unit;
a decoder for decoding the audio data, the video data, and the sub-picture unit into an audio decoding signal, a video decoding signal, a caption image, and a display time information corresponding to the caption image, respectively;
a text recognition module for recognizing the caption image into a first text data; and
a data comparing module for receiving a second text data, comparing the first text data with the second text data, and exporting an analysis result or the display time information corresponding to the second text data.

2. The disk player of claim 1, wherein the text recognition module is an OCR module.

3. The disk player of claim 1, wherein the second text data is input by the user for displaying the AV data corresponding to the second text data.

4. The disk player of claim 1, further comprising a database, wherein the second text data is from the database, and the analysis result is output by the data comparing module.

5. The disk player of claim 4, wherein the database at least comprises either a build-in database or a user-defined database.

6. The disk player of claim 4, further comprising a word selection module, wherein the user uses the word selection module to select the first text data to be input to the data comparing module.

7. The disk player of claim 1, further comprising a user interface, wherein the user interface is electrically coupled to the control module, and the user inputs the operation command to the control module through the user interface.

8. The disk player of claim 1, wherein the decoder comprises:
an audio decoder for receiving and decoding the audio data output by the de-multiplexer, and generating the audio decoding signal;
a video decoder for receiving and decoding the video data output by the de-multiplexer, and generating the video decoding signal; and
a sub-picture decoder for receiving and decoding the sub-picture unit output by the de-multiplexer, and generating the display time information corresponding to the caption image.

9. The disk player of claim 8, further comprising:
a video post process unit for receiving the video decoding signal, the caption image, and the display time information corresponding to the caption image in order to generate a video signal; and
a video output unit for receiving the video signal in order to generate the video output signal.

10. The disk player of claim 8, further comprising:
an audio post process unit for receiving the audio decoding signal in order to generate an audio signal; and
an audio output unit for receiving the audio signal in order to generate the audio output signal.

11. The disk player of claim 1, wherein the navigator outputs a setup signal to the text recognition module for controlling the types of text to be recognized by the text recognition module.

12. A disk player, comprising:
a control module for providing a display control signal based on an operation command;
an AV display unit for reading an AV data based on the display control signal and outputting an audio output signal, a video output signal, a caption image, and a display time information corresponding to the caption image;
a text recognition module for recognizing the caption image into a first text data; and
a data comparing module for receiving a second text data, comparing the first text data with the second text data, and exporting an analysis result or the display time information corresponding to the second text data.

13. The disk player of claim 12, wherein the text recognition module is an OCR module.

14. The disk player of claim 12, further comprising a user interface, wherein the user interface is electrically coupled to the control module; and the user inputs the operation command to the control module through the user interface.

15. The disk player of claim 12, wherein the second text data is input by the user for displaying the AV data corresponding to the second text data.

16. The disk player of claim 12, further comprising a database, wherein the second text data is from the database, and the analysis result is output by the data comparing module.

17. The disk player of claim 16, wherein the database at least comprises either a build-in database or a user-defined database.

18. The disk player of claim 16, further comprising a word selection module; and the user uses the word selection module to select the first text data to be input to the data comparing module.

19. The disk player of claim 12, wherein the data comparing module further comprises receiving a Line-21 information or a plug-in caption information, and data comparing module compares the second text data with the corresponding Line-21 information or the plug-in caption information to output the analysis result or the display time information corresponding to the second text data.

20. The disk player of claim 12, wherein the AV display unit comprises:
a navigator electrically coupled to the control module for reading the AV data according to the display control signal;
a de-multiplexer for dividing the AV data into an audio data, a video data, and a sub-picture unit; and
a decoder for dividing the audio data, the video data, and the sub-picture unit into an audio decoding signal, a video decoding signal, the caption image, and the display time information corresponding to the caption image, respectively.

21. The disk player of claim 20, wherein the decoder comprises:
an audio decoder for receiving and decoding the audio data output by the de-multiplexer, and generating the audio decoding signal;
a video decoder for receiving and decoding the video data output by the de-multiplexer, and generating the video decoding signal; and
a sub-picture decoder for receiving and decoding the sub-picture unit output by the de-multiplexer, and generating the display time information corresponding to the caption image.

22. The disk player of claim 20, further comprising:
a video post process unit for receiving the video decoding signal, the caption image, and the display time information corresponding to the caption image in order to generate a video signal; and
a video output unit for receiving the video signal in order to generate the video output signal.

23. The disk player of claim 20, further comprising:
an audio post process unit for receiving the audio decoding signal in order to generate an audio signal; and
an audio output unit for receiving the audio signal in order to generate the audio output signal.

24. The disk player of claim 12, wherein the navigator outputs a setup signal to the text recognition module for controlling the types of text to be recognized by the text recognition module.

25. A display control method for controlling an AV data display, and the display control method comprising:
decoding a caption image of the AV data and a display time information corresponding to the caption image;
converting the caption image into a first text data;
comparing the first text data with a second text data input by the user; and
outputting the display time information corresponding to the second text data for displaying the AV data corresponded to the display time information.

26. The display control method of claim 25, wherein the method of converting the caption image into the first text data comprises an OCR technique.

27. The display control method of claim 25, wherein the method of decoding the AV data comprises an asynchronous output.

28. A data analyzing method for analyzing an AV data, wherein the display control method comprises:
decoding a caption image of the AV data;
converting the caption image into a first text data;
comparing the first text data with a second text data input by the user or from a database; and
exporting an analysis result.

29. The data analyzing method of claim 28, wherein the method of converting the caption image into the first text data comprises an OCR technique.

30. The data analyzing method of claim 28, wherein the method of comparing the first text data with the second text data from the database comprises a database search technique.

31. The data analyzing method of claim 28, wherein after converting the caption image into the first text data, further comprises a step of selecting a part from the first text data for comparison.

32. The data analyzing method of claim 28, wherein the method of decoding the AV data comprises an asynchronous output.
